(19) United States
(12) Patent Application Publication
(10) Pub. No.: US 2026/0025202 A1
(43) Pub. Date: Jan. 22, 2026

(54) OPTICAL POWER DISTRIBUTION ESTIMATION APPARATUS, OPTICAL POWER DISTRIBUTION ESTIMATION METHOD, AND COMPUTER PROGRAM

(71) Applicant: NTT, Inc., Tokyo (JP)

(72) Inventors: Takeo SASAI, Musashino-shi (JP); Masanori NAKAMURA, Musashino-shi (JP); Etsushi YAMAZAKI, Musashino-shi (JP); Hideki NISHIZAWA, Musashino-shi (JP); Yoshiaki SONE, Musashino-shi (JP); Yoshiaki KISAKA, Musashino-shi (JP)

(73) Assignee: NTT, Inc., Tokyo (JP)

(21) Appl. No.: 19/111,703

(22) PCT Filed: Sep. 15, 2022
(86) PCT No.: PCT/JP2022/034584

§ 371 Date: Mar. 13, 2025

(51) Int. Cl. H04B 10/079; G01M 11/00; H04B 10/61

(52) U.S. Cl. CPC H04B 10/07955; G01M 11/33; H04B 10/61

(57) ABSTRACT

An optical power distribution estimation device including: a coherent receiver that receives a signal transmitted from an optical transmission device via an optical transmission line; and an optical power distribution estimation unit that estimates an optical power distribution on a basis of at least a signal obtained by compensating for or applying a characteristic of an optical reception device to a reception signal received by the coherent receiver or a signal transmitted from the optical transmission device restored on a basis of the reception signal.

### TECHNICAL FIELD

The present invention relates to an optical power distribution estimation device, an optical power distribution estimation method, and a computer program.

### BACKGROUND ART

When an optical transmission system is operated, basic characteristics of an optical fiber included in an optical transmission line greatly affect transmission performance. Here, the basic characteristics of an optical fiber include optical power, distributions of loss and dispersion, and a position of a fault point. For example, when the optical power is too large, an influence of a nonlinear optical effect in the optical fiber increases, and thus a signal-to-noise ratio (hereinafter, referred to as “SNR”) decreases. When the loss is too large, attenuation of the optical power increases accordingly, and thus the SNR decreases.

Therefore, it is important to know the characteristics of the optical fiber in operation, maintenance, and monitoring of the optical transmission system. The optical transmission line includes various devices other than an optical fiber, for example, an optical amplifier, an optical filter, and the like. It is also important to know characteristics of those devices in operation, maintenance, and monitoring of the optical transmission system.

The characteristics of the optical fiber and the devices including the optical amplifier, the optical filter, and the like can be generally measured by an analog measuring instrument such as an optical time domain reflectometer (OTDR) or an optical spectrum analyzer. However, in measurement using the analog measuring instrument, it is necessary to perform direct measurement on each optical node or each optical fiber, which increases an equipment cost and an operating cost.

In order to solve the above issue, digital longitudinal monitoring (DLM), which is a technique for detecting characteristics of various devices in the optical transmission system by digital signal processing on a reception side of the optical transmission system, has been proposed in recent years, instead of measurement using the analog measuring instrument (see, for example, Non Patent Literatures 1 and 2). The DLM is based on a digital coherent optical transmission system and performs digital signal processing on a reception signal obtained by performing coherent detection on an optical signal transmitted through the optical transmission line, thereby monitoring optical power or the like that is a characteristic of the optical transmission line.

### CITATION LIST

### Non Patent Literature

Non Patent Literature 1: T. Tanimura, et al., “Fiber-Longitudinal Anomaly Position Identification Over Multi-Span Transmission Link Out of Receiver-end Signals”, JLT, 38 (9), 2020.
Non Patent Literature 2: T. Sasai, et al., “Digital longitudinal monitoring of Optical Fiber Communication Link”, JLT, 40 (8), 2022.

### SUMMARY OF INVENTION

### Technical Problem

As described above, the DLM is a technique for estimating responses of various devices in an optical transmission system only by digital signal processing on a reception signal of the digital coherent optical transmission system. However, the estimation accuracy of the estimation targets is inferior to that of the analog measuring instrument. This point will be described. In Non Patent Literatures 1 and 2, as illustrated in FIG. 8, optical power is estimated by comparing a reception signal A[L] that is an actual optical transmission line output with a simulation signal A^{ref}[L] propagated through an optical transmission line on a digital domain (digital-twin link).

Here, as techniques for estimating optical power, an estimation method by a correlation method described in Non Patent Literature 1 and an estimation method by a least squares method described in Non Patent Literature 2 have been proposed. In the estimation method by the correlation method described in Non Patent Literature 1, optical power is estimated by acquiring a “correlation” between the reception signal A[L] and the simulation signal A_{ref}[L]. In the estimation method by the least squares method described in Non Patent Literature 2, optical power is estimated by determining an optical transmission line parameter such that a square error between the reception signal A[L] and the simulation signal A^{ref}[L] is minimized.

In a case where optical power is estimated by the above-described DLM, it is desirable that the actual optical transmission line and the optical transmission line on the digital domain have the same characteristics. However, in the conventional method, the optical transmission line on the digital domain cannot sufficiently simulate the characteristics of the actual optical transmission line. Therefore, there has been an issue that the spatial resolution and the estimation accuracy are low although simple measurement can be performed as compared with an analog measuring instrument.

In view of the above circumstances, an object of the present invention is to provide a technique capable of estimating an optical power distribution having high spatial resolution with high accuracy in an optical power distribution estimation technique by digital signal processing.

### Solution to Problem

An aspect of the present invention is an optical power distribution estimation device including: a coherent receiver that receives a signal transmitted from an optical transmission device via an optical transmission line; and an optical power distribution estimation unit that estimates an optical power distribution on a basis of at least a signal obtained by compensating for or applying a characteristic of an optical reception device to a reception signal received by the coherent receiver or a signal transmitted from the optical transmission device restored on a basis of the reception signal.

An aspect of the present invention is an optical power distribution estimation method including: receiving a signal transmitted from an optical transmission device via an optical transmission line; and estimating an optical power distribution on a basis of at least a signal obtained by compensating for or applying a characteristic of an optical reception device to a received reception signal or a signal transmitted from the optical transmission device restored on a basis of the reception signal.

An aspect of the present invention is a computer program that causes a computer to execute: a reception step of receiving a signal transmitted from an optical transmission device via an optical transmission line; and an optical power distribution estimation step of estimating an optical power distribution on a basis of at least a signal obtained by compensating for or applying a characteristic of an optical reception device to a received reception signal or a signal transmitted from the optical transmission device restored on a basis of the reception signal.

### Advantageous Effects of Invention

According to the present invention, it is possible to estimate an optical power distribution having high spatial resolution with high accuracy in an optical power distribution estimation technique by digital signal processing.

### BRIEF DESCRIPTION OF DRAWINGS

FIG. 1 A diagram for describing an outline of optical power distribution estimation processing in a first embodiment.

FIG. 2 A diagram illustrating a configuration example of an optical reception device according to the first embodiment.

FIG. 3 A diagram illustrating configuration examples of an optical transmission device characteristic application unit and an optical reception device characteristic application unit according to the first embodiment.

FIG. 4 A flowchart illustrating a flow of processing of the optical reception device according to the first embodiment.

FIG. 5 A diagram illustrating a configuration example of an optical transmission system according to a modification of the first embodiment.

FIG. 6 A diagram for describing an outline of optical power distribution estimation processing in a second embodiment.

FIG. 7 A diagram illustrating a configuration example of an optical transmission system according to the second embodiment.

FIG. 8 A diagram for describing an outline of conventional optical power distribution estimation processing.

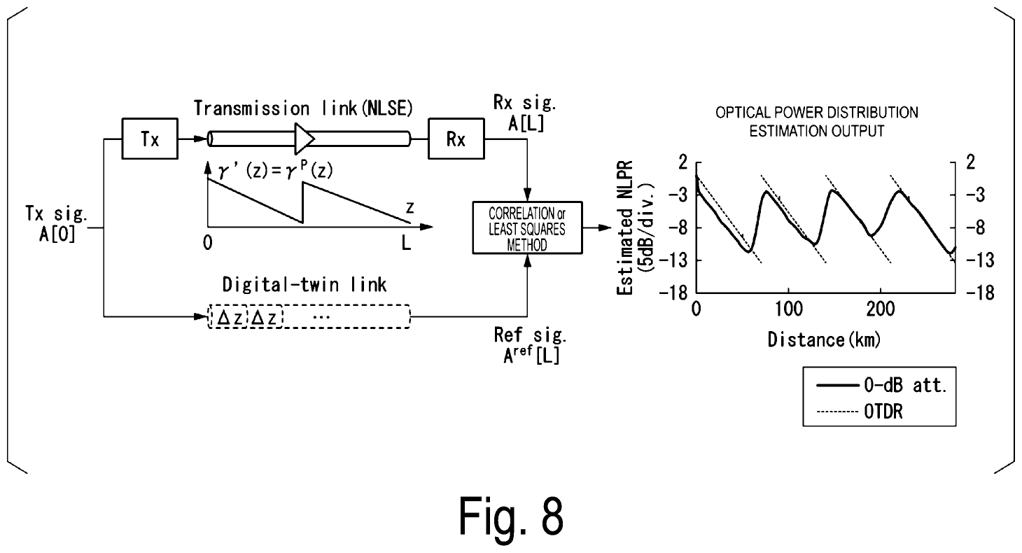

### DESCRIPTION OF EMBODIMENTS

Hereinafter, embodiments of the present invention will be described with reference to the drawings.

### First Embodiment

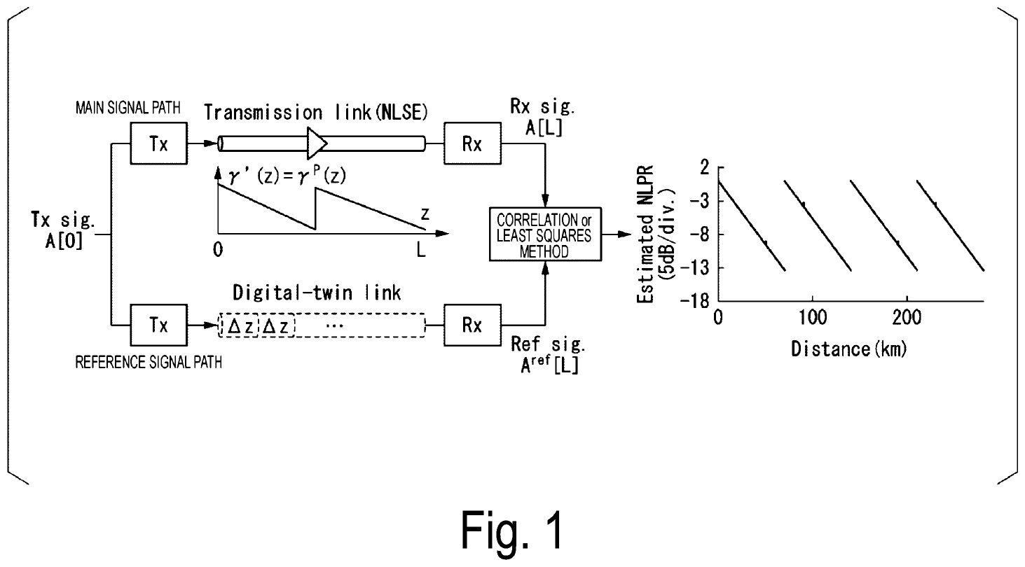

FIG. 1 is a diagram for describing an outline of optical power distribution estimation processing in a first embodiment. In the first embodiment, as illustrated in FIG. 1, characteristics (for example, frequency characteristics (amplitude/phase), inter-lane crosstalk, skew, gain imbalance, and the like) of an optical transmission device and an optical reception device included in an optical transmission system are estimated in advance, and the estimated characteristics of the optical transmission device and the optical reception device are simulated on an optical transmission line in a digital domain (digital-twin link). Specifically, in an actual optical transmission line, a transmission signal A[0] is affected by the characteristics of the optical transmission device and the characteristics of the optical reception device during a period from when the transmission signal A[0] is generated by the optical transmission device to when the transmission signal A[0] is received by the optical reception device.

In the conventional method, such estimation of an optical power distribution in consideration of the characteristics of the optical transmission device and the optical reception device has not been performed. Therefore, in the first embodiment, the estimated characteristics of the optical transmission device and the optical reception device are applied to a signal propagated through the optical transmission line on the digital domain, similarly to the actual optical transmission line. Accordingly, the actual optical transmission line and the optical transmission line on the digital domain are brought closer to the same characteristics. As a result, the estimation accuracy and the resolution can be improved.

Note that the characteristics of the optical transmission device and the characteristics of the optical reception device may be measured or estimated by any method before use. For example, each analog device may be measured by a measuring instrument, or estimation may be performed by system identification by digital signal processing on the basis of a reception signal and a transmission signal. As a result, the optical power distribution illustrated in the right diagram can be estimated. Hereinafter, specific configurations for implementing the above processing will be described.

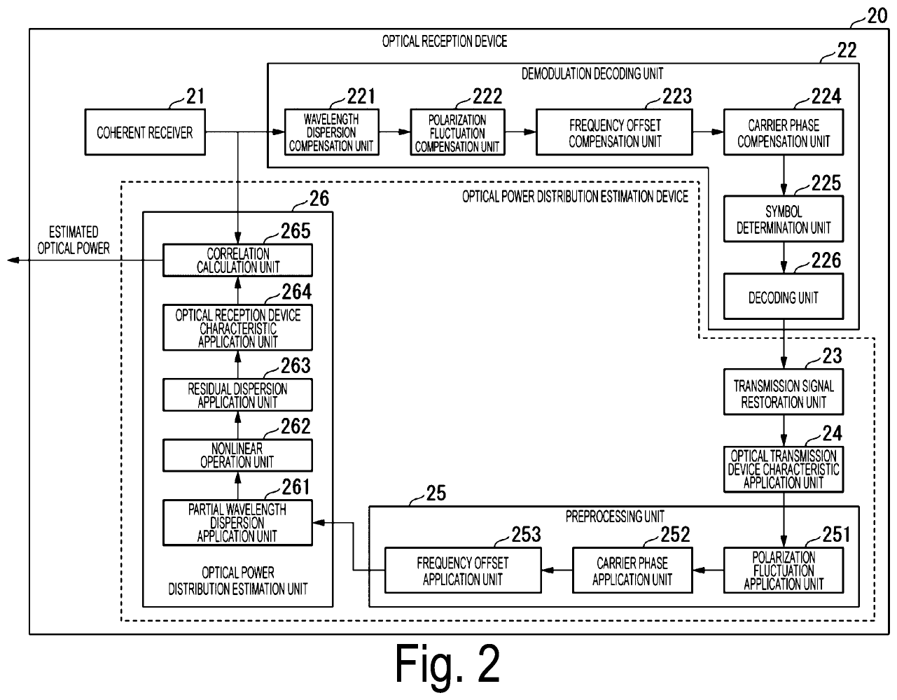

FIG. 2 is a diagram illustrating a configuration example of an optical reception device 20 according to the first embodiment. The optical reception device 20 is connected to an optical transmission device included in an optical transmission system via an optical transmission line. The optical transmission line is, for example, an optical fiber. The optical reception device 20 receives a transmission signal transmitted from the optical transmission device via the optical transmission line. The optical reception device 20 includes a coherent receiver 21, a demodulation decoding unit 22, a transmission signal restoration unit 23, an optical transmission device characteristic application unit 24, a preprocessing unit 25, and an optical power distribution estimation unit 26. Note that the transmission signal restoration unit 23, the optical transmission device characteristic application unit 24, the preprocessing unit 25, and the optical power distribution estimation unit 26 are configured as an optical power distribution estimation device.

The coherent receiver 21 is connected to the optical transmission line, receives an optical signal (e.g. transmission signal) transmitted through the optical transmission line, and performs coherent detection. The coherent receiver 21 separates polarization of the received optical signal into X-polarization and Y-polarization. The coherent receiver 21 causes each of the X-polarization and Y-polarization optical signals after the polarization separation to interfere with laser light emitted from a local oscillation light source included therein, thereby detecting the I-component and the Q-component of the X-polarization and the Y-polarization. The coherent receiver 21 converts the I-component and Q-component optical signals of the X-polarization and the Y-polarization into four series of analog electric signals. The coherent receiver 21 converts the converted four series of analog signals into four series of digital signals by using four analog-to-digital converters included therein and outputs the four series of digital signals. Hereinafter, the four series of digital signals output from the coherent receiver 21 will be referred to as a reception signal.

The demodulation decoding unit 22 compensates for an influence caused by the optical transmission line with respect to the reception signal output from the coherent receiver 21 and decodes the reception signal. Examples of the influence caused by the optical transmission line include wavelength dispersion, polarization fluctuation, a frequency offset, and a carrier phase. The demodulation decoding unit 22 includes a wavelength dispersion compensation unit 221, a polarization fluctuation compensation unit 222, a frequency offset compensation unit 223, a carrier phase compensation unit 224, a symbol determination unit 225, and a decoding unit 226.

The wavelength dispersion compensation unit 221 estimates wavelength dispersion received in the optical transmission line and compensates for the estimated wavelength dispersion with respect to the reception signal output from the coherent receiver 21.

The polarization fluctuation compensation unit 222 compensates for distortion generated in a waveform of the reception signal in the optical transmission line by using the reception signal whose wavelength dispersion has been compensated for by the wavelength dispersion compensation unit 221. That is, the polarization fluctuation compensation unit 222 corrects a symbol error generated in the reception signal due to inter-symbol interference in the optical transmission line. For example, the polarization fluctuation compensation unit 222 may perform adaptive equalization processing by using a finite impulse response (FIR) filter according to a set tap coefficient. Note that the polarization fluctuation compensation unit 222 may compensate for the distortion generated in the waveform of the reception signal by a method other than the above which adaptively compensates for the polarization fluctuation.

The frequency offset compensation unit 223 executes processing of compensating for a frequency offset with respect to the reception signal compensated by the polarization fluctuation compensation unit 222.

The carrier phase compensation unit 224 executes processing of compensating for a phase offset with respect to the reception signal whose frequency offset has been compensated for. The symbol determination unit 225 performs symbol determination on the reception signal whose phase offset has been compensated for.

The decoding unit 226 decodes the reception signal on the basis of a result of the symbol determination by the symbol determination unit 225.

The transmission signal restoration unit 23 restores the transmission signal by using the reception signal decoded by the demodulation decoding unit 22. That is, the transmission signal restoration unit 23 restores the transmission signal transmitted from the optical transmission device on the basis of the signal in which the influence caused by the optical transmission line has been compensated for.

The optical transmission device characteristic application unit 24 applies the characteristics of the optical transmission device to the restored transmission signal. The optical transmission device characteristic application unit 24 applies the characteristics of the optical transmission device by convolving the characteristics of the optical transmission device estimated in advance into the restored transmission signal by a convolution operation. As a result, the optical transmission device characteristic application unit 24 can bring the restored transmission signal closer to the transmission signal transmitted by the optical transmission device.

The preprocessing unit 25 performs predetermined processing on the transmission signal to which the characteristics of the optical transmission device have been applied by the optical transmission device characteristic application unit 24. Here, the predetermined processing is processing of applying a value corresponding to the influence caused by the optical transmission line to the transmission signal in order to bring the transmission signal close to the reception signal. The preprocessing unit 25 includes a polarization fluctuation application unit 251, a carrier phase application unit 252, and a frequency offset application unit 253.

The polarization fluctuation application unit 251 applies the same value as the distortion generated in the waveform of the reception signal compensated for by the polarization fluctuation compensation unit 222 to the transmission signal restored by the transmission signal restoration unit 23.

The carrier phase application unit 252 applies the same value as the phase offset compensated for by the carrier phase compensation unit 224 to the transmission signal to which the same value as the distortion has been applied by the polarization fluctuation application unit 251.

The frequency offset application unit 253 applies the same value as that of the frequency offset compensated for by the frequency offset compensation unit 223 to the transmission signal to which the same value as the phase offset has been applied by the carrier phase application unit 252.

As described above, the preprocessing unit 25 generates a signal in which a value of the wavelength dispersion has been removed from the reception signal received by the coherent receiver 21. Hereinafter, the transmission signal processed by the preprocessing unit 25 will be referred to as a preprocessed transmission signal.

The optical power distribution estimation unit 26 estimates an optical power distribution (optical transmission characteristic) of the optical transmission line by a predetermined estimation algorithm. Here, an estimation algorithm based on a correlation method will be described as an example of the predetermined estimation algorithm. The optical power distribution estimation unit 26 includes a partial wavelength dispersion application unit 261, a nonlinear operation unit 262, a residual dispersion application unit 263, an optical reception device characteristic application unit 264, and a correlation calculation unit 265.

The partial wavelength dispersion application unit 261 applies a value of wavelength dispersion corresponding to a distance from the optical transmission device to an optical power measurement position zₖ to the preprocessed transmission signal. Hereinafter, the value of the wavelength dispersion corresponding to the distance from the optical transmission device to the optical power measurement position zₖ will be referred to as a partial wavelength dispersion value. For example, in a case where k=10 is satisfied, the partial wavelength dispersion application unit 261 estimates the partial wavelength dispersion value corresponding to a distance from the optical transmission device to an optical power measurement position z₁₀ and applies the estimated partial wavelength dispersion value to the preprocessed transmission signal.

The lower limit of the optical power measurement position zₖ is, for example, a position (k=0) of the optical transmission device, and the upper limit of the optical power measurement position zₖ is, for example, a position of the optical reception device 20. The partial wavelength dispersion application unit 261 performs the above processing at all optical power measurement positions.

The nonlinear operation unit 262 performs nonlinear operation on the transmission signal to which the value of the partial wavelength dispersion has been applied by the partial wavelength dispersion application unit 261. More specifically, the nonlinear operation unit 262 may use the following Formula (1) used for phase rotation on the transmission signal to which the value of the partial wavelength dispersion has been applied, or may use nonlinear operation based on Formula (2) using a linear term obtained by Taylor-expanding Formula (1). In Formulas (1) and (2), uₒᵤₜ denotes an output from the nonlinear operation unit, and uᵢₙ denotes the transmission signal to which the value of the partial wavelength dispersion has been applied.

$$\begin{matrix}[ Math . 1 ] & \\ {u}_{out} = {u}_{in} \cdot exp ( - j ε ( {\vert {u}_{in , x} \vert}^{2} + {\vert {u}_{in , y} \vert}^{2} ) ) & Formula ( 1 )\end{matrix}$$

$$( {u}_{in} = [ \begin{matrix}{u}_{in , x} \\ {u}_{in , y}\end{matrix} ] , {u}_{out} = [ \begin{matrix}{u}_{out , x} \\ {u}_{out , y}\end{matrix} ] , ε is any real number set by user )$$

$$\begin{matrix}[ Math . 2 ] & \\ {u}_{out} = {u}_{in} \cdot ( - j ε ( {\vert {u}_{in , x} \vert}^{2} + {\vert {u}_{in , y} \vert}^{2} ) ) & Formula ( 2 )\end{matrix}$$

$$( {u}_{in} = [ \begin{matrix}{u}_{in , x} \\ {u}_{in , y}\end{matrix} ] , {u}_{out} = [ \begin{matrix}{u}_{out , x} \\ {u}_{out , y}\end{matrix} ] , ■ )$$

The residual dispersion application unit 263 applies a value of wavelength dispersion corresponding to a distance from the optical power measurement position zₖ to the optical reception device 20 to the transmission signal subjected to the nonlinear operation. Thus, the residual dispersion application unit 263 applies a value of wavelength dispersion corresponding to a remaining distance for which no value has been applied by the partial wavelength dispersion application unit 261. Hereinafter, the value of the wavelength dispersion corresponding to the distance from the optical power measurement position zₖ to the optical reception device 20 will be referred to as a residual wavelength dispersion value.

The optical reception device characteristic application unit 264 applies the characteristics of the optical reception device 20 to the transmission signal to which the residual wavelength dispersion value has been applied and which has been output from the residual dispersion application unit 263. The optical reception device characteristic application unit 264 applies the characteristics of the optical reception device 20 by convolving the characteristics of the optical reception device 20 estimated in advance into the transmission signal to which the residual wavelength dispersion value has been applied by a convolution operation. As a result, the optical reception device characteristic application unit 264 can bring the transmission signal closer to the reception signal received by the optical reception device.

The correlation calculation unit 265 correlates the reception signal output from the coherent receiver 21 with the transmission signal to which the characteristics of the optical reception device have been applied by the optical reception device characteristic application unit 264. The correlation calculation unit 265 performs this processing for each of the optical power measurement positions. At this time, an operation of taking an absolute value may be performed before correlating the two signals. The correlation calculation unit 265 estimates an estimated power distribution by plotting a correlation result (correlation value) obtained for each of the optical power measurement positions. At this time, in a case where an absolute value is not taken in advance before the correlation is performed, the estimated power output by the correlation calculation unit 265 is a complex value. In this case, when plotting is performed, a real part of the estimated power is taken or an absolute value is taken and then plotting is performed.

In the description here, a method of “applying” partial wavelength dispersion, nonlinear operation, and residual wavelength dispersion to a restored transmission signal is adopted. However, the method may be a method of “compensating for” partial wavelength dispersion, nonlinear operation, and residual wavelength dispersion with respect for the reception signal.

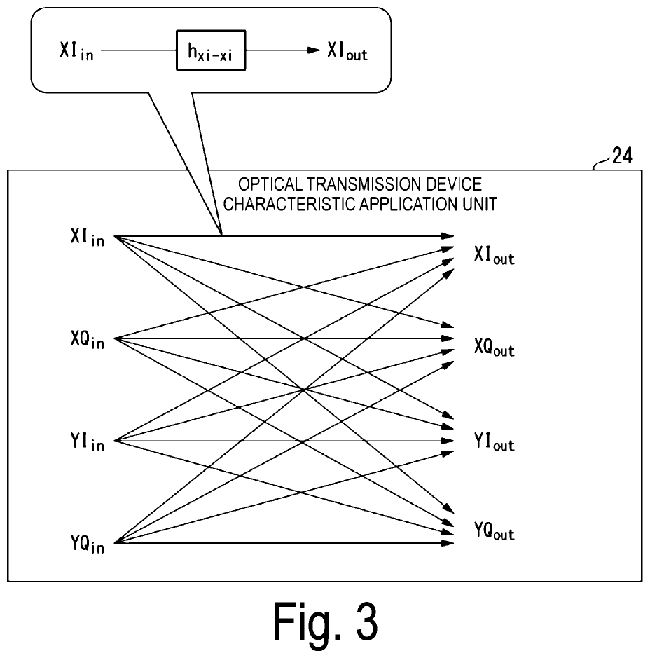

FIG. 3 is a diagram illustrating configuration examples of the optical transmission device characteristic application unit 24 and the optical reception device characteristic application unit 264 according to the first embodiment. Note that the optical transmission device characteristic application unit 24 and the optical reception device characteristic application unit 264 have similar configurations, and perform the same processing except that the characteristics to be applied are different, and thus the optical transmission device characteristic application unit 24 will be described as an example in FIG. 3. The optical transmission device characteristic application unit 24 performs a multiple-input and multiple-output (MIMO) operation including inter-lane crosstalk for each of the I-component and Q-component optical signals of the X-polarization and the Y-polarization in four series.

Each line that extends from ooᵢₙ to ooₒᵤₜ illustrated in FIG. 3 denotes convolution by the FIR filter. Note that any one of values XI, XQ, YI, and YQ is input to oo. As an example, a line that extends from XIᵢₙ to XIₒᵤₜ represents an operation represented by the following Formula (3).

$$\begin{matrix}[ Math . 3 ] & \\ {XI}_{out} [ n ] = {h}_{XI - XI} [ n ] ⊗ {XI}_{in} [ n ] & Formula ( 3 )\end{matrix}$$

Here, hₓᵢ₋ₓᵢ denotes a response characteristic between XIᵢₙ and XIₒᵤₜ of the optical transmission device. Note that, in the case of the optical reception device characteristic application unit 264, hₓᵢ₋ₓᵢ denotes a response characteristic between XIᵢₙ and XIₒᵤₜ of the optical reception device 20. n in the Formula (3) denotes a time sample. The optical transmission device characteristic application unit 24 and the optical reception device characteristic application unit 264 simulate the frequency characteristics and the inter-lane imbalance of the optical transmission device and the optical reception device by performing the above-described operation on each line that extends from ooᵢₙ to ooₒᵤₜ.

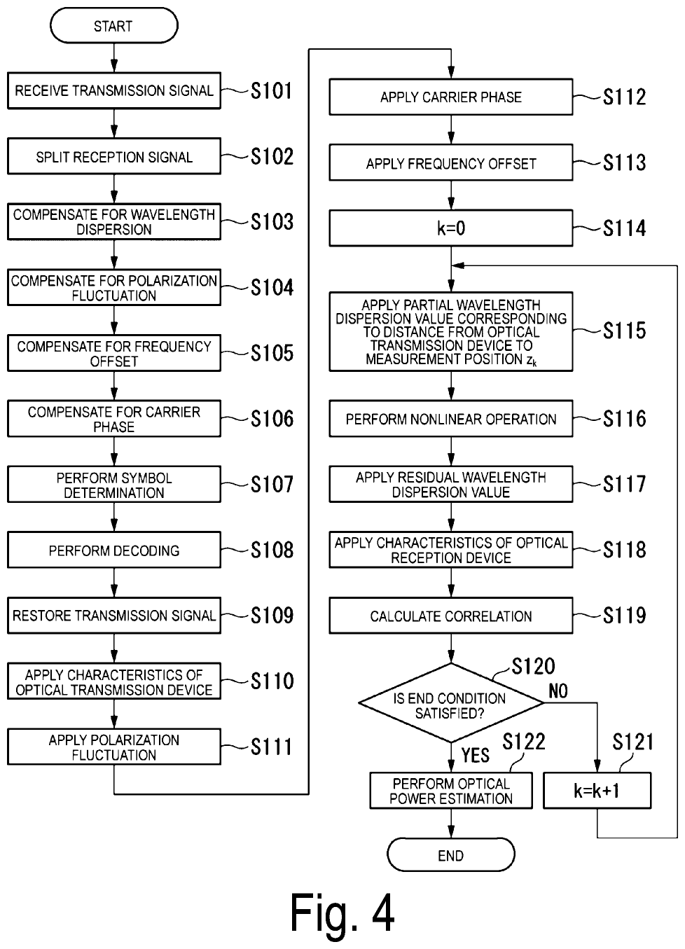

FIG. 4 is a flowchart illustrating a flow of processing of the optical reception device 20 according to the first embodiment.

The coherent receiver 21 receives a transmission signal transmitted from the optical transmission device via the optical transmission line (step S101). The coherent receiver 21 outputs the received reception signal. The reception signal output from the coherent receiver 21 is split and input to the demodulation decoding unit 22 and the optical power distribution estimation unit 26 (step S102).

The wavelength dispersion compensation unit 221 estimates wavelength dispersion received in the optical transmission line and compensates for the estimated wavelength dispersion with respect to the reception signal output from the coherent receiver 21 (step S103). The wavelength dispersion compensation unit 221 outputs the reception signal whose wavelength dispersion has been compensated for to the polarization fluctuation compensation unit 222. The polarization fluctuation compensation unit 222 compensates for distortion generated in a waveform of the reception signal in the optical transmission line by using the reception signal whose wavelength dispersion has been compensated for and which has been output from the wavelength dispersion compensation unit 221 (step S104). The polarization fluctuation compensation unit 222 outputs the compensated reception signal to the frequency offset compensation unit 223.

The frequency offset compensation unit 223 compensates for a frequency offset with respect to the reception signal compensated by the polarization fluctuation compensation unit 222 (step S105). The frequency offset compensation unit 223 outputs the reception signal whose frequency offset has been compensated for to the carrier phase compensation unit 224. The carrier phase compensation unit 224 compensates for a phase offset with respect to the reception signal whose frequency offset has been compensated for by the frequency offset compensation unit 223 (step S106). The carrier phase compensation unit 224 outputs the reception signal whose phase offset has been compensated for to the symbol determination unit 225.

The symbol determination unit 225 performs symbol determination on the reception signal whose phase offset has been compensated for (step S107). The symbol determination unit 225 outputs a result of the symbol determination to the decoding unit 226. The decoding unit 226 decodes the reception signal on the basis of the result of the symbol determination by the symbol determination unit 225 (step S108). The decoding unit 226 outputs the decoded reception signal to the transmission signal restoration unit 23.

The transmission signal restoration unit 23 restores the transmission signal by using the reception signal decoded by the demodulation decoding unit 22 (step S109). The transmission signal restoration unit 23 outputs the restored transmission signal to the optical transmission device characteristic application unit 24. The optical transmission device characteristic application unit 24 applies the characteristics of the optical transmission device to the transmission signal output from the transmission signal restoration unit 23 (step S110). The optical transmission device characteristic application unit 24 outputs the transmission signal after the application of the characteristics of the optical transmission device to the polarization fluctuation application unit 251.

The polarization fluctuation application unit 251 applies the same value as the distortion generated in the waveform of the reception signal compensated by the polarization fluctuation compensation unit 222 with respect to the transmission signal after the application of the characteristics of the optical transmission device, which is output from the optical transmission device characteristic application unit 24 (step S111). The polarization fluctuation application unit 251 outputs the transmission signal after the application to the carrier phase application unit 252.

The carrier phase application unit 252 applies the same value as the phase offset compensated for by the carrier phase compensation unit 224 to the transmission signal after the application, which is output from the polarization fluctuation application unit 251 (step S112). The carrier phase application unit 252 outputs the transmission signal after the application to the frequency offset application unit 253. The frequency offset application unit 253 applies the same value as that of the frequency offset compensated for by the frequency offset compensation unit 223 to the transmission signal after the application, which is output from the carrier phase application unit 252 (step S113). The frequency offset application unit 253 outputs the transmission signal after the application to the optical power distribution estimation unit 26.

The partial wavelength dispersion application unit 261 sets k=0 (step S114) and estimates a value of wavelength dispersion corresponding to a distance from the optical transmission device to the optical power measurement position zₖ. For example, k=0 is satisfied in step S114, and thus, here, the partial wavelength dispersion application unit 261 estimates a partial wavelength dispersion value that is a value of wavelength dispersion corresponding to a distance from the optical transmission device to the optical power measurement position z₀. The partial wavelength dispersion application unit 261 applies the estimated partial wavelength dispersion value to the transmission signal after the application, which is output from the frequency offset application unit 253 (step S115). The partial wavelength dispersion application unit 261 outputs the transmission signal to which the partial wavelength dispersion value has been applied to the nonlinear operation unit 262.

The nonlinear operation unit 262 performs nonlinear operation based on Formula (2) above by using the transmission signal after the application of the partial wavelength dispersion value, which is output from the partial wavelength dispersion application unit 261 (step S116). The nonlinear operation unit 262 outputs the transmission signal subjected to the nonlinear operation to the residual dispersion application unit 263. The residual dispersion application unit 263 estimates a value of wavelength dispersion corresponding to a distance from the optical power measurement position zₖ to the optical reception device 20. For example, the residual dispersion application unit 263 estimates a residual wavelength dispersion value that is a value of wavelength dispersion corresponding to a distance from the optical power measurement position z₀ to the optical reception device 20. The residual dispersion application unit 263 applies the estimated residual wavelength dispersion value to the transmission signal subjected to the nonlinear operation and output from the nonlinear operation unit 262 (step S117). The residual dispersion application unit 263 outputs the transmission signal to which the residual wavelength dispersion value has been applied to the optical reception device characteristic application unit 264.

The optical reception device characteristic application unit 264 applies the characteristics of the optical reception device 20 to the transmission signal after the application of the residual wavelength dispersion value, which is output from the residual dispersion application unit 263 (step S118). The optical reception device characteristic application unit 264 outputs the transmission signal after the application of the characteristics of the optical reception device 20 to the correlation calculation unit 265. The correlation calculation unit 265 correlates the reception signal output from the coherent receiver 21 with the transmission signal after the application of the characteristics of the optical reception device 20, which is output from the optical reception device characteristic application unit 264 (step S119). Thereafter, the correlation calculation unit 265 determines whether or not an end condition is satisfied (step S120). Here, the end condition is a condition for ending calculation of the correlation and may be, for example, that the calculation of the correlation from all the optical power measurement positions is completed.

If it is determined that the end condition is not satisfied (step S120-NO), the correlation calculation unit 265 adds a value 1 to k (step S121). Thereafter, the optical reception device 20 repeatedly executes the processing in step S115 and subsequent steps. For example, in a case where the added value is k=1, the partial wavelength dispersion application unit 261 estimates a value of wavelength dispersion corresponding to a distance from the optical transmission device to an optical power measurement position z₁ in the processing of step S115. The partial wavelength dispersion application unit 261 applies the estimated partial wavelength dispersion value to the transmission signal after the application, which is output from the frequency offset application unit 253.

Thereafter, the processing from steps S115 to S119 is executed with k=1. Thereafter, the correlation calculation unit 265 determines whether or not the end condition is satisfied again (step S120). As described above, the processing from step S115 to step S119 is repeatedly executed until the correlation is acquired at all the optical power measurement positions.

In the processing of step S120, if it is determined that the end condition is satisfied (step S120—YES), the correlation calculation unit 265 performs optical power estimation by using the correlation result acquired for each of the optical power measurement positions (step S122). Specifically, the correlation calculation unit 265 estimates an estimated power distribution by plotting the correlation result acquired for each of the optical power measurement positions.

According to the optical reception device 20 configured as described above, an optical power distribution can be estimated in consideration of characteristics of the optical transmission device and the optical reception device that are not simulated by the conventional optical transmission line on a digital domain. Therefore, an optical power distribution having high spatial resolution can be estimated with high accuracy.

### Modification 1

In the above-described embodiment, the configuration has been described in which the optical transmission device characteristic application unit 24 and the optical reception device characteristic application unit 264 apply all the characteristics. The optical transmission device characteristic application unit 24 and the optical reception device characteristic application unit 264 may be configured to apply only some characteristics. In the case of such a configuration, the optical transmission device characteristic application unit 24 and the optical reception device characteristic application unit 264 perform an MIMO operation except for some characteristics (for example, it is set to 0), instead of performing an MIMO operation on all combinations.

### Modification 2

In the above-described embodiment, the configuration using the correlation method has been described as a technique of optical power distribution estimation, but the optical power distribution estimation unit 26 may be configured to estimate an optical power distribution by the least squares method. In the case of such a configuration, the optical power distribution estimation unit 26 estimates optical power by determining an optical transmission line parameter such that a square error between a reception signal output from the coherent receiver 21 and a transmission signal to which the characteristics of the optical reception device have been applied by the optical reception device characteristic application unit 264 is minimized.

### Modification 3

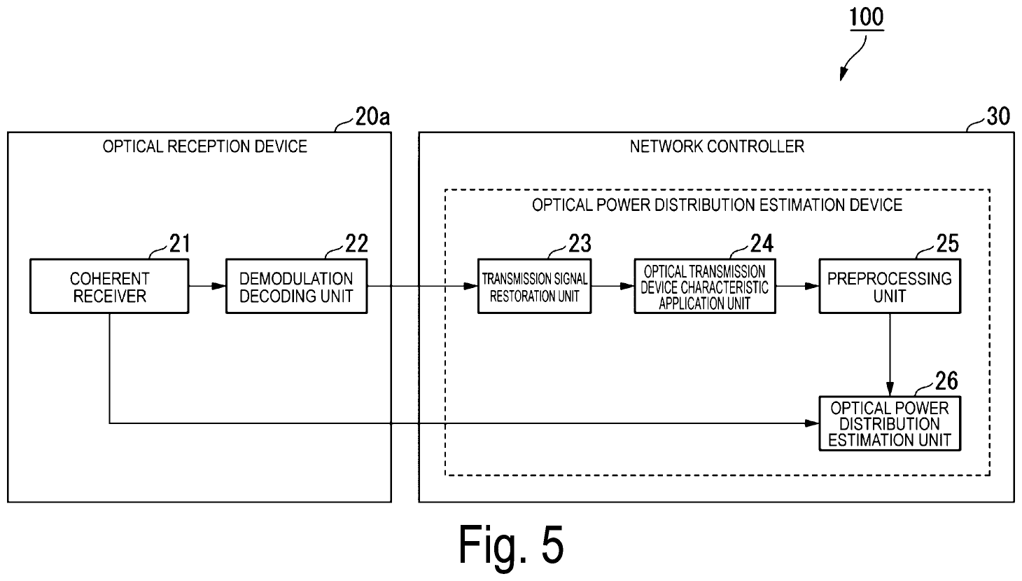

The estimation processing of an optical power distribution may be performed in a network controller that manages the optical transmission system. FIG. 5 is a diagram illustrating a configuration example of an optical transmission system 100 according to a modification of the first embodiment. The optical transmission system 100 includes an optical transmission device (not illustrated), an optical reception device 20a, and a network controller 30. The optical transmission system 100 may include a plurality of optical reception devices 20a. The optical transmission device (not illustrated) and the optical reception device 20a are connected by an optical transmission line, and the optical reception device 20a and the network controller 30 are connected by an electric line. The optical reception device 20a receives a transmission signal transmitted from an optical transmission device connected via an optical transmission line. The network controller 30 is a host device that manages the optical transmission system 100.

The optical reception device 20a includes the coherent receiver 21 and the demodulation decoding unit 22. The network controller 30 includes the transmission signal restoration unit 23, the optical transmission device characteristic application unit 24, the preprocessing unit 25, and the optical power distribution estimation unit 26. Processing performed by the coherent receiver 21, the demodulation decoding unit 22, the transmission signal restoration unit 23, the optical transmission device characteristic application unit 24, the preprocessing unit 25, and the optical power distribution estimation unit 26 is basically the same as that in the above-described embodiment. Hereinafter, differences from the above-described embodiment will be described.

The coherent receiver 21 outputs a reception signal to the demodulation decoding unit 22 and also to the optical power distribution estimation unit 26 included in the network controller 30 via the electric line. The demodulation decoding unit 22 outputs the decoded reception signal to the transmission signal restoration unit 23 included in the network controller 30 via the electric line.

Each functional unit included in the network controller 30 performs processing similar to that in the above-described embodiment.

According to the optical transmission system 100 configured as described above, the network controller 30 serving as a host device that manages the optical transmission system 100 estimates an optical power distribution. This makes it possible to reduce a processing load of one optical reception device 20a.

Further, in a case where a plurality of optical reception devices 20a is connected to the network controller 30, the network controller 30 can estimate the optical power distribution for each of the optical reception devices 20a. Therefore, it is unnecessary to estimate the optical power distribution in each of the optical reception devices 20a, and thus each of the optical reception devices 20a does not need to include a function of estimating the optical power distribution. Further, one network controller 30 estimates optical power distributions for the plurality of optical reception devices 20a, and thus it is possible to efficiently estimate the optical power distributions.

### Second Embodiment

In a second embodiment, a configuration using inverse characteristics of an optical transmission device and an optical reception device will be described.

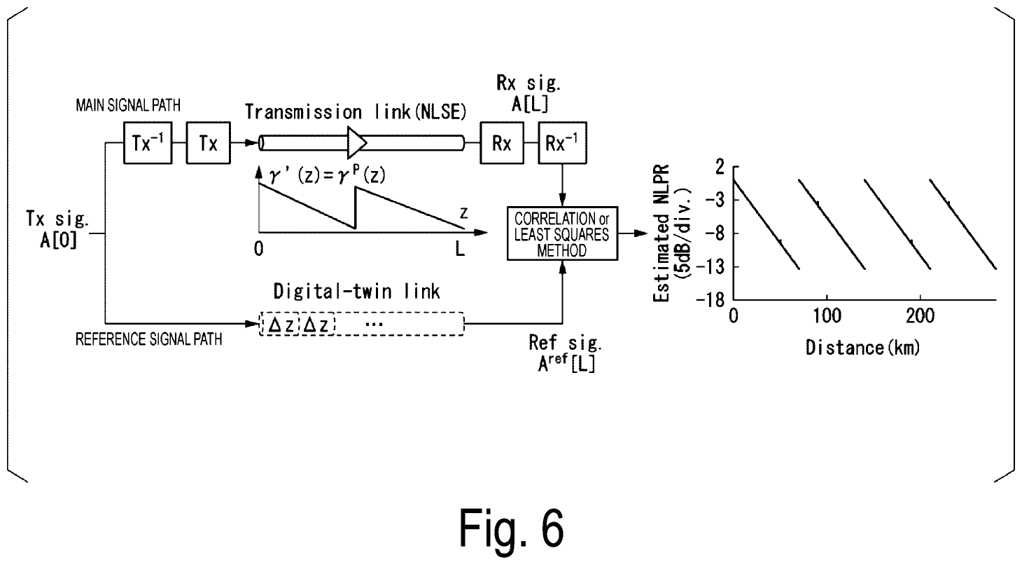

FIG. 6 is a diagram for describing an outline of optical power distribution estimation processing in the second embodiment. In the second embodiment, as illustrated in FIG. 6, inverse characteristics of the optical transmission device and the optical reception device included in an optical transmission system are estimated in advance, and a signal transmitted and received on an actual optical transmission line (signal transmitted from the optical transmission device and received by the optical reception device) is compensated with the estimated inverse characteristics of the optical transmission device and the optical reception device. Accordingly, the actual optical transmission line and an optical transmission line on a digital domain are brought closer to the same characteristics. As a result, the estimation accuracy and the resolution can be improved.

Note that the inverse characteristics of the optical transmission device and the inverse characteristics of the optical reception device may be measured or estimated by any method before use. For example, each analog device may be measured by a measuring instrument, or estimation may be performed by system identification by digital signal processing on the basis of a reception signal and a transmission signal. As a result, the optical power distribution illustrated in the right diagram can be estimated. Hereinafter, specific configurations for implementing the above processing will be described.

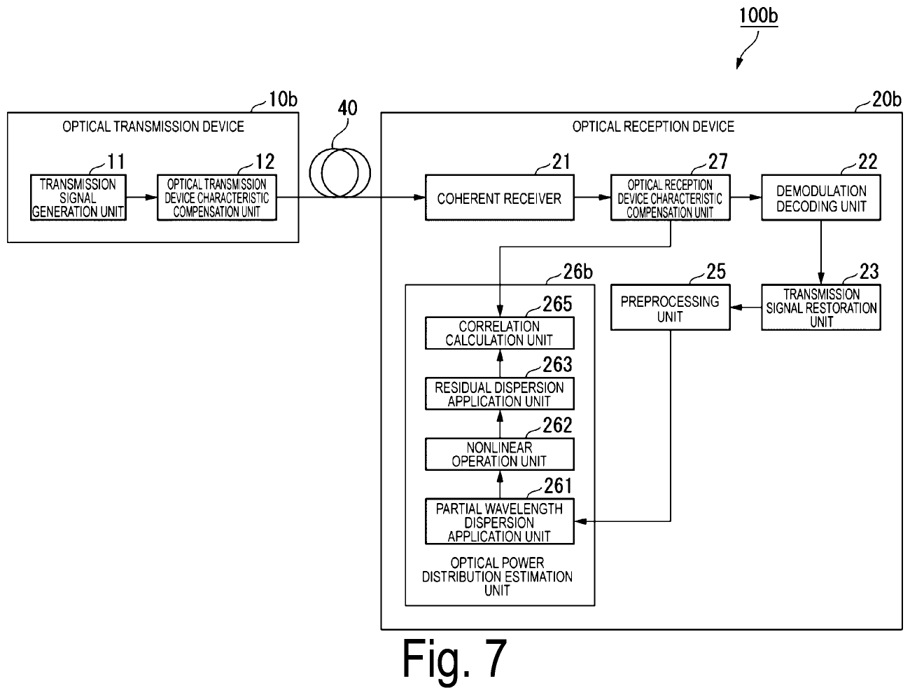

FIG. 7 is a diagram illustrating a configuration example of an optical transmission system 100b in the second embodiment. The optical transmission system 100b includes an optical transmission device 10b and an optical reception device 20b. The optical transmission device 10b and the optical reception device 20b are connected via an optical transmission line 40.

The optical transmission device 10b includes a transmission signal generation unit 11 and an optical transmission device characteristic compensation unit 12. The transmission signal generation unit 11 generates an optical signal to be transmitted. The optical transmission device characteristic compensation unit 12 compensates for the characteristics of the optical transmission device 10b in the transmission signal with respect to the transmission signal generated by the transmission signal generation unit 11 by using the inverse characteristics of the optical transmission device 10b estimated in advance. Specifically, the optical transmission device characteristic compensation unit 12 compensates for the characteristics of the optical transmission device 10b with respect to the transmission signal generated by the transmission signal generation unit 11 by convolving the inverse characteristics of the optical transmission device 10b estimated in advance by a convolution operation.

The optical reception device 20b receives a transmission signal transmitted from the optical transmission device 10b via the optical transmission line 40. The optical reception device 20b includes a coherent receiver 21, a demodulation decoding unit 22, a transmission signal restoration unit 23, a preprocessing unit 25, an optical power distribution estimation unit 26b, and an optical reception device characteristic compensation unit 27. Note that the transmission signal restoration unit 23, the preprocessing unit 25, the optical power distribution estimation unit 26b, and the optical reception device characteristic compensation unit 27 are configured as an optical power distribution estimation device.

The optical reception device 20b is different from the optical reception device 20 in that the optical transmission device characteristic application unit 24 is not included, the optical power distribution estimation unit 26b is included instead of the optical power distribution estimation unit 26, and the optical reception device characteristic compensation unit 27 is further included. Other configurations of the optical reception device 20b are similar to those of the optical reception device 20. Hereinafter, differences from the optical reception device 20 will be mainly described.

The optical reception device characteristic compensation unit 27 compensates for the characteristics of the optical reception device 20b in a reception signal with respect to the reception signal generated by the coherent receiver 21 by using the inverse characteristics of the optical reception device 20b estimated in advance. The optical reception device characteristic compensation unit 27 compensates for the characteristics of the optical reception device 20b with respect to the reception signal by convolving the inverse characteristics of the optical reception device 20b estimated in advance by a convolution operation.

According to the optical transmission system 100b configured as described above, the optical transmission device 10b transmits a signal obtained by compensating for the characteristics of the optical transmission device 10b as a transmission signal, and the optical reception device 20b compensates for the characteristics of the optical reception device 20b with respect to the transmission signal transmitted from the optical transmission device 10b. Accordingly, the actual optical transmission line and an optical transmission line on a digital domain can be brought closer to the same characteristics. As a result, the estimation accuracy and the resolution can be improved.

### Modification 1

In the above-described embodiment, the configuration has been described in which the optical transmission device characteristic compensation unit 12 and the optical reception device characteristic compensation unit 27 compensate for all the characteristics. The optical transmission device characteristic compensation unit 12 and the optical reception device characteristic compensation unit 27 may be configured to compensate for only some characteristics. In the case of such a configuration, the optical transmission device characteristic compensation unit 12 and the optical reception device characteristic compensation unit 27 perform an MIMO operation except for some characteristics (for example, it is set to 0), instead of performing an MIMO operation on all combinations.

### Modification 2

In the above-described embodiment, the configuration using the correlation method has been described as a technique of optical power distribution estimation, but the optical power distribution estimation unit 26b may be configured to estimate an optical power distribution by the least squares method. In the case of such a configuration, the optical power distribution estimation unit 26b estimates optical power by determining an optical transmission line parameter such that a square error between a reception signal obtained by compensating for the characteristics of the optical transmission device and the optical reception device and a restored transmission signal is minimized.

### Modification Common to First Embodiment and Second Embodiment

In each embodiment, some of the characteristics may be “compensated for in a main signal path” and some may be “applied to a reference signal path”. There are many combinations, but any combination may be used.

Some or all of the functional units of the optical transmission device 10b, the optical reception devices 20, 20a, and 20b and the network controller 30 described above are implemented as software by causing a processor such as a central processing unit (CPU) to execute a program stored in a storage device including a nonvolatile recording medium (non-transitory recording medium) and a storage unit. The program may be recorded in a computer-readable non-transitory recording medium. The computer-readable non-transitory recording medium is a non-transitory recording medium such as a portable medium including, for example, a flexible disk, a magneto-optical disk, a read only memory (ROM), and a compact disc read only memory (CD-ROM) or a storage device such as a hard disk built in a computer system.

Some or all of the functional units of the optical transmission device 10b, the optical reception devices 20, 20a, and 20b and the network controller 30 described above may be implemented by using hardware including an electronic circuit (or circuitry) using, for example, a large scale integrated circuit (LSI), an application specific integrated circuit (ASIC), a programmable logic device (PLD), or a field programmable gate array (FPGA).

Although the embodiments of the present invention have been described in detail with reference to the drawings, specific configurations are not limited to the embodiments and include design and the like within the gist of the present invention.

### INDUSTRIAL APPLICABILITY

The present invention can be applied to a technique of estimating transmission characteristics in a digital coherent optical transmission system.

### REFERENCE SIGNS LIST

10b Optical transmission device
11 Transmission signal generation unit
12 Optical transmission device characteristic compensation unit
20, 20a, 20b Optical reception device
21 Coherent receiver
22 Demodulation decoding unit
23 Transmission signal restoration unit
24 Optical transmission device characteristic application unit
25 Preprocessing unit
26, 26b Optical power distribution estimation unit
27 Optical reception device characteristic compensation unit
30 Network controller
221 Wavelength dispersion compensation unit
222 Polarization fluctuation compensation unit
223 Frequency offset compensation unit
224 Carrier phase compensation unit
225 Symbol determination unit
226 Decoding unit
251 Polarization fluctuation application unit
252 Carrier phase application unit
253 Frequency offset application unit
261 Partial wavelength dispersion application unit
262 Nonlinear operation unit
263 Residual dispersion application unit
264 Optical reception device characteristic application unit
265 Correlation calculation unit

1. An optical power distribution estimation device comprising:
a coherent receiver configured to receive a signal transmitted from an optical transmission device via an optical transmission line; and
an optical power distribution estimator configured to estimate an optical power distribution on a basis of at least a signal obtained by compensating for or applying a characteristic of an optical reception device to a reception signal received by the coherent receiver or a signal transmitted from the optical transmission device restored on a basis of the reception signal.

2. The optical power distribution estimation device according to claim 1 further comprising:
a transmission signal restorer configured to restore a signal transmitted from the optical transmission device on a basis of the reception signal;
an optical transmission device characteristic applicator configured to apply a characteristic of the optical transmission device to the restored signal; and
an optical reception device characteristic applicator configured to apply a characteristic of the optical reception device to the signal to which a characteristic of the optical transmission device has been applied,
wherein the optical power distribution estimator estimates the optical power distribution by using the reception signal and the signal to which a characteristic of the optical transmission device and a characteristic of the optical reception device have been applied.

3. The optical power distribution estimation device according to claim 2,
wherein the optical transmission device characteristic applicator and the optical reception device characteristic applicator apply a characteristic of the optical transmission device and a characteristic of the optical reception device estimated in advance by convolving the restored signal by a convolution operation.

4. The optical power distribution estimation device according to claim 1,
wherein the reception signal is a signal obtained by compensating for a characteristic of the optical transmission device in the optical transmission device,
the optical power distribution estimation device further comprises:
an optical reception device characteristic compensator configured to compensate for a characteristic of the optical reception device with respect to the reception signal; and
a transmission signal restorer configured to restore a signal transmitted from the optical transmission device on a basis of a reception signal obtained by compensating for a characteristic of the optical transmission device and a characteristic of the optical reception device, and
the optical power distribution estimator estimates the optical power distribution by using the reception signal obtained by compensating for a characteristic of the optical transmission device and a characteristic of the optical reception device and a restored signal.

5. The optical power distribution estimation device according to claim 4,
wherein the optical reception device characteristic compensator compensates for an inverse characteristic of the optical reception device estimated in advance by convolving the reception signal by a convolution operation.

6. An optical power distribution estimation method comprising:
receiving a signal transmitted from an optical transmission device via an optical transmission line; and
estimating an optical power distribution on a basis of at least a signal obtained by compensating for or applying a characteristic of an optical reception device to a received reception signal or a signal transmitted from the optical transmission device restored on a basis of the reception signal.

7. A non-transitory storage medium that stores a program for making a computer perform processes, the processes comprising:
receiving a signal transmitted from an optical transmission device via an optical transmission line; and
estimating an optical power distribution on a basis of at least a signal obtained by compensating for or applying a characteristic of an optical reception device to a received reception signal or a signal transmitted from the optical transmission device restored on a basis of the reception signal.
